(19) United States
(12) Patent Application Publication
(10) Pub. No.: US 2026/0118688 A1
(43) Pub. Date: Apr. 30, 2026

(54) OPTICAL STRUCTURE AND DISPLAY APPARATUS

(71) Applicants: Beijing Zitiao Network Technology Co., Ltd., Beijing (CN); Lemon Inc., Grand Cayman (KY)

(72) Inventors: Shaopeng ZHU, Beijing (CN); Ziyang ZHANG, Los Angeles, CA (US); Guang ZHENG, Beijing (CN); Jian CHEN, Beijing (CN); Yao TIAN, Beijing (CN); Xiaokai LI, Beijing (CN)

(21) Appl. No.: 19/345,349

(22) Filed: Sep. 30, 2025

(30) Foreign Application Priority Data
Oct. 31, 2024 (CN) 202411541418.3

(51) Int. Cl. G02B 27/28; G02B 27/00

(52) U.S. Cl. CPC G02B 27/286; G02B 27/0093; G02B 27/283

(57) ABSTRACT

An optical structure and a display apparatus are provided. The optical structure includes a lens structure, a beam splitting film, a phase retardation film and a reflective polarizing film. The plurality of metal layers includes a mixed metal layer, a material of the mixed metal layer includes at least two metals, and the at least two metals include a first metal and a second metal. The non-metal layer that is in direct contact with the mixed metal layer and located on a side of the mixed metal layer close to the lens structure is a layer to be deposited, and an interfacial energy between the first metal and the layer to be deposited is less than an interfacial energy between the second metal and the layer to be deposited.

### CROSS-REFERENCE TO RELATED APPLICATION

This application claims the priority to and benefits of the Chinese Patent Application, No. 202411541418.3, which was filed on Oct. 31, 2024. All the aforementioned patent applications are hereby incorporated by reference in their entireties.

### TECHNICAL FIELD

Embodiments of the present disclosure relate to an optical structure and a display apparatus.

### BACKGROUND

In virtual Reality (VR) and mixed reality (MR) devices, near-eye displays use lenses to magnify images shown on display screens to bring people a sense of immersion.

The combination of a display screen and a lens is called an opto-mechanical module. The existing opto-mechanical module includes the combination of a liquid crystal display (LCD) or silicon-based organic light-emitting diode (OLED) screen and a folded optical path lens (i.e., Pancake). The opto-mechanical module achieves a thin and light effect through the modulation on polarized light by a special polarized optical assembly.

### SUMMARY

At least one embodiment of the present disclosure provides an optical structure, including a light incident side and a light exit side, including: a lens structure, including a first surface and a second surface disposed opposite each other, the first surface being a surface of the lens structure on the light incident side; a beam splitting film, located on a side of the first surface away from the second surface; a phase retardation film, located on a side of the second surface away from the first surface; and a reflective polarizing film, located on the side of the second surface away from the first surface, wherein the beam splitting film includes a plurality of film layers arranged in a stacked manner along a thickness direction of the beam splitting film, the plurality of film layers includes a plurality of metal layers and at least one non-metal layer, one or more non-metal layer of the at least one non-metal layer are disposed between two adjacent metal layers of the plurality of metal layers, the plurality of metal layers includes a mixed metal layer, a material of the mixed metal layer includes at least two metals, and the at least two metals include a first metal and a second metal, a non-metal layer that is in direct contact with the mixed metal layer and located on a side of the mixed metal layer close to the lens structure is a layer to be deposited, at least part of the first metal of the mixed metal layer is in direct contact with the layer to be deposited, and an interfacial energy between the first metal and the layer to be deposited is less than an interfacial energy between the second metal and the layer to be deposited.

For example, in the optical structure according to an embodiment of the present disclosure, a content of the first metal in the mixed metal layer is a ratio of a mass of the first metal to a total mass of the mixed metal layer, and the content of the first metal in the mixed metal layer is not greater than 30%.

For example, in the optical structure according to an embodiment of the present disclosure, a light absorptance of the second metal is less than a light absorptance of the first metal, and the content of the first metal in the mixed metal layer is not greater than 15%.

For example, in the optical structure according to an embodiment of the present disclosure, the mixed metal layer includes a first-type mixed metal layer, and the first metal of the first-type mixed metal layer is doped in the second metal.

For example, in the optical structure according to an embodiment of the present disclosure, the first type of mixed metal layer includes a first mixed metal layer, and the first metal of the first mixed metal layer is uniformly doped in the second metal.

For example, in the optical structure according to an embodiment of the present disclosure, the first type of mixed metal layer includes a second mixed metal layer, along a thickness direction of the second mixed metal layer, a ratio of the first metal to the second metal is variable.

For example, in the optical structure according to an embodiment of the present disclosure, in a thickness direction of the mixed metal layer and away from the lens structure, the ratio of the first metal to the second metal first decreases and then increases.

For example, in the optical structure according to an embodiment of the present disclosure, the mixed metal layer includes a second-type mixed metal layer, the second-type mixed metal layer includes a plurality of sublayers arranged in a stacked manner, the plurality of sublayers includes a nearest sublayer closest to the lens structure, and a material of the nearest sublayer includes the first metal.

For example, in the optical structure according to an embodiment of the present disclosure, the material of the nearest sublayer of the second-type mixed metal layer is the first metal, and a material of each sublayer of the plurality of sublayers other than the nearest sublayer is the second metal.

For example, in the optical structure according to an embodiment of the present disclosure, a thickness of the nearest sublayer is not greater than 2 nm.

For example, in the optical structure according to an embodiment of the present disclosure, the material of the nearest sublayer of the second type mixed metal layer further includes the second metal, and a content of the first metal in the nearest sublayer is not greater than 30%.

For example, in the optical structure according to an embodiment of the present disclosure, the plurality of sublayers further includes a farthest sublayer farthest away from the lens structure, a material of the farthest sublayer includes the first metal and the second metal, a content of the first metal in the farthest sublayer is not greater than 30%, and a material of each sublayer of the plurality of sublayers other than the nearest sublayer and the farthest sublayer is the second metal.

For example, in the optical structure according to an embodiment of the present disclosure, a material of a non-metal layer in direct contact with the nearest sublayer is an oxide of the first metal.

For example, in the optical structure according to an embodiment of the present disclosure, a thickness of the mixed metal layer is in a range from 5 nm to 25 nm.

For example, in the optical structure according to an embodiment of the present disclosure, the thickness of the mixed metal layer is not greater than 15 nm.

For example, in the optical structure according to an embodiment of the present disclosure, the first metal is one selected from the group consisting of aluminum, nickel, chromium, zinc, copper, gold, titanium, indium, germanium, and the second metal is silver.

For example, in the optical structure according to an embodiment of the present disclosure, the at least one non-metal layer includes a plurality of non-metal layers, the plurality of metal layers includes a nearest metal layer closest to the lens structure and a farthest metal layer farthest away from the lens structure, at least one layer of the plurality of non-metal layers is disposed between the nearest metal layer and the lens structure, and at least one layer of the plurality of non-metal layers is disposed on a side of the farthest metal layer away from the lens structure.

At least one embodiment of the present disclosure provides a display apparatus, including a display screen and an above-mentioned optical structure, wherein the display screen is located on the light incident side of the optical structure.

For example, in the optical structure according to an embodiment of the present disclosure further including a tracking structure, wherein the tracking structure is located on the light incident side of the optical structure, the tracking structure is configured to receive light in a set band and exited from the optical structure, and the display screen includes a micro organic light-emitting diode display screen.

### BRIEF DESCRIPTION OF DRAWINGS

In order to more clearly illustrate the technical solutions of the embodiments of the present disclosure, the accompanying drawings of the embodiments will be briefly introduced below, it is obvious that the accompanying drawings in the following description merely relate to some embodiments of the present disclosure, but not the limitations of the present disclosure.

FIG. 1 is a schematic structural view of a display apparatus.

FIG. 2 is a curve chart of reflectance and transmittance of light incident at different incident angles on a medium beam splitting film.

FIG. 3 is a schematic view of an optical path of a display apparatus including an eye tracking structure.

FIG. 4 is a curve chart of reflectance and transmittance of light incident at different incident angles on a beam splitting film.

FIG. 5 is a sectional view of an optical structure according to an embodiment of the present disclosure.

FIG. 6 is a partially enlarged sectional view of the optical structure shown in FIG. 5.

FIG. 7 is another partially enlarged sectional view of the optical structure shown in FIG. 5.

FIG. 8 is another partially enlarged sectional view of the optical structure shown in FIG. 5.

FIG. 9 is a curve chart of reflectance and transmittance of light incident at different incident angles on the beam splitting film shown in FIG. 8.

FIG. 10 is another partially enlarged sectional view of the optical structure shown in FIG. 5.

FIG. 11 is a curve chart of reflectance and transmittance of light incident at different incident angles on the beam splitting film shown in FIG. 10.

FIG. 12 is another partially enlarged sectional view of the optical structure shown in FIG. 5.

FIG. 13 is a curve chart of reflectance and transmittance of light incident at different incident angles on the beam splitting film shown in FIG. 12.

FIG. 14 is another partially enlarged sectional view of the optical structure shown in FIG. 6.

FIG. 15 is a curve chart of reflectance and transmittance of light incident at different incident angles on the beam splitting film shown in FIG. 14.

FIG. 16 is a sectional view of an optical structure according to an embodiment of the present disclosure.

FIG. 17 is a partially enlarged sectional view of the optical structure shown in FIG. 16 at position B.

FIG. 18 is a curve chart of reflectance and transmittance of light incident at different incident angles on the beam splitting film shown in FIG. 16.

FIG. 19 is a sectional view of a display apparatus according to an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first”, “second”, etc., which are used in the present disclosure, are not intended to indicate any sequence, amount or importance, but distinguish various components. Also, the terms “comprise,” “comprising.” “include.” “including.” etc., are intended to specify that the elements or the objects stated before these terms encompass the elements or the objects and equivalents thereof listed after these terms, but do not preclude the other elements or objects.

Unless otherwise defined, the features used in the embodiment of the present disclosure, such as “parallel”, “vertical”, and “identical”, all include strictly defined situations such as “parallel”, “vertical”, and “identical”, as well as situations where “roughly parallel”, “roughly vertical”, and “roughly identical” contain certain errors. For example, the above “roughly” can indicate that the difference between the compared objects is 10% of the average value of the compared objects, or within 5%. When the number of a component or an element is not specifically specified in the following embodiment of the present disclosure, it refers to that the component or the element can be one or multiple, or can be understood as at least one. “At least one” refers to one or more, and “multiple” refers to at least two.

Pancake lens technology has become the mainstream lens technology for virtual reality and mixed reality near-eye display systems, and has been adopted by various virtual reality and mixed reality near-eye display manufacturers. A pancake lens typically consists of a lens and a beam splitting film, a phase retardation film, a reflective polarizing film and a polarized absorption film formed on the lens. The beam splitting film can reflect and transmit light simultaneously, for example, the beam splitting film may be a semi-transmissive and semi-reflective film. The phase retardation film has a fast axis and a slow axis, which can covert light in a circularly polarized state to light in a linearly polarized state, or covert light in a linearly polarized state to light in a circularly polarized state. The reflective polarizing film has a reflection axis and a transmission axis, which reflects linearly polarized light parallel to the direction of the reflection axis while keeping the polarized state of the linearly polarized light unchanged, and transmits linearly polarized light parallel to the direction of the transmission axis while keeping the polarized state of the linearly polarized light unchanged. The polarized absorption film has a transmission axis. The direction of the transmission axis of the polarized absorption film is parallel to the transmission axis of the reflective polarizing film. The fast axis of the phase retardation film is at 45 degrees or 135 degrees to the transmission axis of the reflective polarizing film.

FIG. 1 is a schematic structural view of a display apparatus. A display screen 05 in (a) of FIG. 1 is a liquid crystal display (LCD) screen, and the display screen 05 of (b) of FIG. 1 is a micro organic light-emitting diode display (micro OLED) screen. As shown in FIG. 1, the display apparatus includes a Pancake lens and the display screen 05. The Pancake lens includes a lens 01, a beam splitting film 02, a quarter-wave phase retardation film 03, and a reflective polarizing film 04. The beam splitting film 02 is located on a curved surface of a side of the lens 01 close to the display screen 05. The quarter-wave phase retardation film 03 can change the polarized state of light and enables conversion between the circularly polarized light and the linearly polarized light. The reflective polarizing film 04 is located on a surface of a side of the lens 01 far away from the display screen 05. The reflective polarizing film 04 can transmit polarized light (e.g., S-light) in one direction and reflect polarized light (e.g., P-light) in another direction. Light exited from the display screen 05 passes through the Pancake lens to complete the folding of optical path, thereby greatly reducing a required distance between the near-eye display device and the human eye.

For the Pancake lens, the key to forming the folded optical path is the conversion between circularly polarized light and linearly polarized light, and ellipticity of the circularly polarized light within the folded optical path is an important physical quantity that determines optical performance of the Pancake lens. When the ellipticity is 1, it represents that the circularly polarized light is perfectly circularly polarized light, when the ellipticity is 0, it represents that the circularly polarized light is perfectly linearly polarized light. When the ellipticity is between 0 and 1, it is elliptically polarized light, and the closer the ellipticity is to 1, the closer the polarized light is to circularly polarized light. The principle of Pancake lens requires that the ellipticity of the circularly polarized light within the folded optical path (e.g., optical paths 2, 3, and 4 shown in FIG. 1) is as close to 1 as possible, and in response to a low ellipticity, part of light does not follow the designed folded optical path but forms stray light or ghosting, affecting optical quality of images.

For the Pancake lens, the factors that affect the ellipticity includes: (1) Quarter-wave phase retardation film (QWP). The ideal QWP requires that when linearly polarized light is incident at an angle of 45 degrees to its optical axis, retardation of the linearly polarized light is exactly ¼ of its wavelength such that circularly polarized light with an ellipticity of 1 can be formed. When the retardation is insufficient or greater than ¼ of the wavelength, elliptically polarized light with an ellipticity of less than 1 will be formed. (2) Material of lens. The material of the lens needs to have extremely low birefringence property, otherwise, when polarized light passes through the lens, the phase of the polarized light is prone to retardation under the influence of the birefringence property of the lens, which affects the ellipticity and distribution of the polarized light.

However, for the Pancake lens, there is another determinant that has been neglected to affect the ellipticity, i.e., polarized splitting of the beam splitting film. A conventional beam splitting film is formed of 6 to 10 layers of medium film by plating, to achieve specific transmittance and reflectance (e.g., the transmittance and the reflectance are both 50%). However, according to optical properties of the medium film of the beam splitting film, when light is incident obliquely, reflectance of an S-polarized component and reflectance of a P-polarized component of the light with respect to an incident plane are not consistent, and transmittance of the S-polarized component and transmittance of the P-polarized component of the light with respect to the incident plane are also not consistent. In other words, when perfectly circularly polarized light is incident obliquely to a surface of the beam splitting film, both transmitted light and reflected light of the perfectly circularly polarized light become elliptically polarized light, i.e., the ellipticity decreases.

An existing VR device based on the Pancake lens has a screen in a near-eye display module as a liquid crystal display screen as shown in (a) of FIG. 1. For example, the liquid crystal display screen has a typical size of 2 inches or more, and the display screen 05 has a size comparable to a size of the lens 01. For example, as shown in (a) of FIG. 1, a surface of the display screen 05 is combined with a wave plate to emit circularly polarized light, and when the circularly polarized light is incident to the beam splitting film 02 of the Pancake lens, incident angle α of the circularly polarized light is relatively small, e.g., the incident angle α is less than 20 degrees. In response to the relatively small incident angle α, a difference between transmittance Tp of a P-polarized component and transmittance Ts of an S-polarized component of the medium beam splitting film 02 is not large, and accordingly the decrease in ellipticity is not large.

However, as shown in (b) of FIG. 1, when the display screen 05 of the display apparatus is a screen of smaller size such as a micro organic light-emitting diode display screen. The size of the lens 01 cannot be reduced in equal proportion to the size of the display screen 05 due to the need for the size of the lens 01 to match viewing angle of the human eye, and the size of the display screen 05 will be substantially smaller than the size of the lens 01. At this time, when circularly polarized light emitted from the display screen 05 through a wave plate is incident on the beam splitting film 02 on the lens 01, part of the circularly polarized light has a relatively large incident angle α, e.g., the incident angle α is between 20 degrees and 50 degrees. In response to the relatively large incident angle α, the difference between the transmittance Tp of the P-polarized component and the transmittance Ts of the S-polarized component of the medium beam splitting film 02 is large, so that the ellipticity of the circularly polarized light will be substantially reduced after the circularly polarized light passes through the beam splitting film 02, resulting in the formation of stray light and ghosting, which affects the viewing effect.

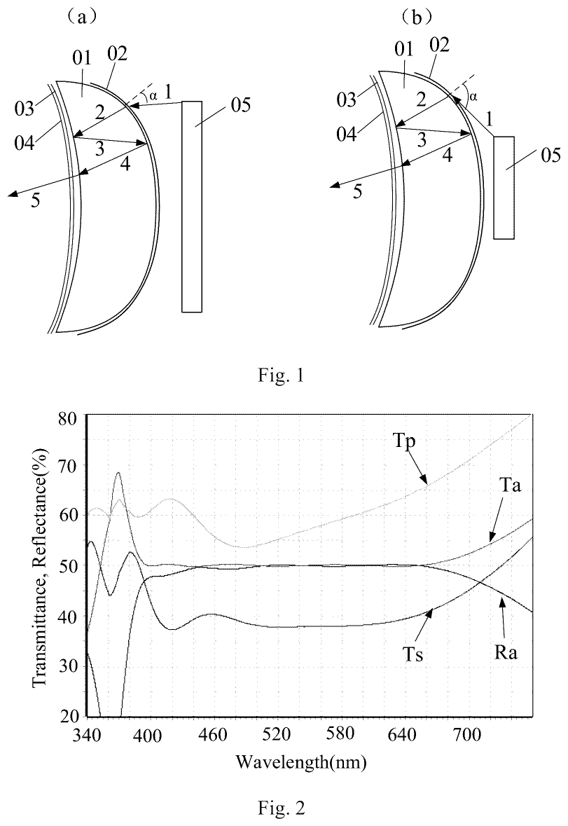

FIG. 2 is a curve chart of reflectance and transmittance of light incident at different incident angles on a medium beam splitting film. The figure shows reflectance Ra and transmittance Ta of the incident light when the incident angle of the incident light on the medium beam splitting film is 0 degrees, and transmittance Ts of a S-polarized component and transmittance Tp of a P-polarized component of the incident light when the incident angle of the incident light is 40 degrees. As shown in FIG. 2, in a visible light band, when the incident angle is 40 degrees, the transmittance Ts of the S-polarized component and the transmittance Tp of the P-polarized component deviate from target values (the target values are both 50%), and the difference between the transmittance Ts of the S-polarized component and the transmittance Tp of the P-polarized component is relatively large, resulting unsatisfactory beam splitting effect of the beam splitting film.

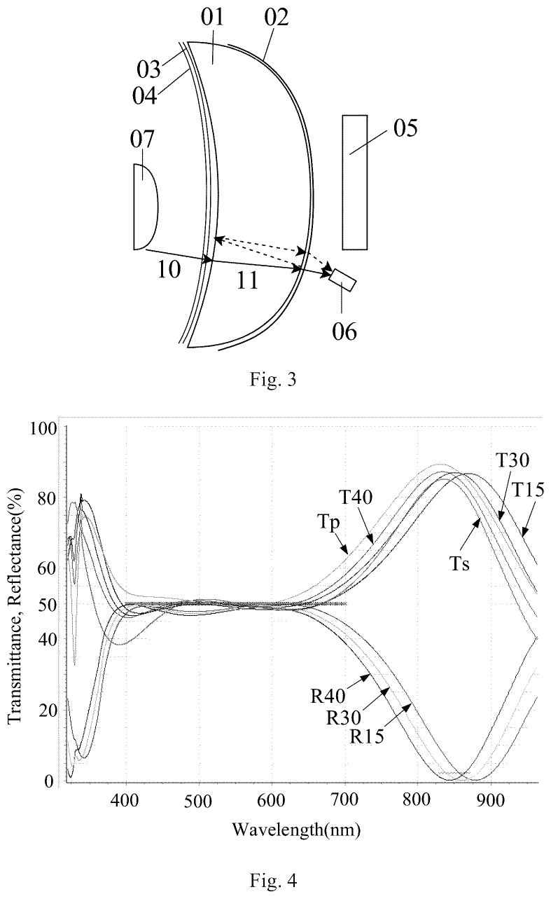

FIG. 3 is a schematic view of an optical path of a display apparatus including an eye tracking structure. As shown in FIG. 3, the eye tracking structure of the display apparatus is an infrared camera 06. An infrared signal 10 reflected from an eye ball 07 passes through the Pancake lens and is captured by the infrared camera 06 to enable movement tracking of the eye ball 07. However, when the beam splitting film 02 of the Pancake lens has a high reflectance of light in a near-infrared band, for example, when the reflectance reaches 60%, an infrared signal 11 passing through the Pancake lens to arrive at the surface of the beam splitting film 02 will form a light path of the dotted line as in the figure due to the high reflectance of the beam splitting film, which will cause interference with the infrared imaging of the human eye.

FIG. 4 is a curve chart of reflectance and transmittance of light incident at different incident angles on a beam splitting film. The beam splitting film includes a titanium dioxide layer, a silver layer, a silicon dioxide layer, a titanium dioxide layer, an aluminum trioxide layer, a silver layer, and a silicon dioxide layer formed on the lens sequentially, and the thicknesses of the respective film layers are 16.214 nm, 9.298 nm, 93.004 nm, 58.625 nm, 6.076 nm, 12.321 nm, and 82.174 nm, respectively. The figure shows reflectance R15 and transmittance T15 of the incident light at an incident angle of 15 degrees, reflectance R30 and transmittance T30 of the incident light at an incident angle of 30 degrees, reflectance R40 and transmittance T40 of the incident light at an incident angle of 40 degrees, and transmittance Ts of an S-polarized component and transmittance Tp of a P-polarized component of the incident light at an incident angle of 40 degrees.

As shown in FIG. 4, in a visible light band, when the incident angle is 40 degrees, the transmittance Ts of the S-polarized component and the transmittance Tp of the P-polarized component of the incident light are basically equal to target values (the target values are both 50%), and the reflectance of the light is very low at a wavelength of 850 nm. However, the beam splitting film cannot be used in actual production. The reason for this is that the thicknesses of two silver layers of the beam splitting film are about 9 nm and 12 nm respectively, which are already lower than a percolation threshold (i.e., the minimum thickness of silver that can form a continuous film under set conditions) of silver metal, the percolation threshold of silver metal is about 15 nm. That is, after plating of the beam splitting film, the two silver layers are of a discontinuous island-like structure instead of a continuous film such that optical parameters of the two silver layers deviate significantly from the design optical parameters. As the two silver layers are of the discontinuous island-like structure, the bonding force between the two silver layers and adjacent non-metal layers is very poor, the silver layers are highly susceptible to oxidization in the air, and accordingly, it is not possible to obtain a stable and reliable beam splitting film.

Embodiments of the present disclosure provide an optical structure and a display apparatus. The optical structure includes a light incident side and a light exit side. The optical structure includes a lens structure, a beam splitting film, a phase retardation film and a reflective polarizing film. The lens structure includes a first surface and a second surface disposed opposite each other, the first surface being a surface of the lens structure on the light incident side. The beam splitting film is located on a side of the first surface away from the second surface; the phase retardation film is located on a side of the second surface away from the first surface; and the reflective polarizing film is located on the side of the second surface away from the first surface. The beam splitting film includes a plurality of film layers arranged in a stacked manner along a thickness direction of the beam splitting film, the plurality of film layers includes a plurality of metal layers and at least one non-metal layer, one or more non-metal layer of the at least one non-metal layer are disposed between two adjacent metal layers of the plurality of metal layers. The plurality of metal layers includes a mixed metal layer, a material of the mixed metal layer includes at least two metals, and the at least two metals include a first metal and a second metal. A non-metal layer that is in direct contact with the mixed metal layer and located on a side of the mixed metal layer close to the lens structure is a layer to be deposited, at least part of the first metal of the mixed metal layer is in direct contact with the layer to be deposited, and an interfacial energy between the first metal and the layer to be deposited is less than an interfacial energy between the second metal and the layer to be deposited. In the present disclosure, the non-metal layer that is in direct contact with the mixed metal layer and located on a side of the mixed metal layer close to the lens structure is a layer to be deposited of the mixed metal layer, and the mixed metal layer is formed or deposited on the layer to be deposited.

In the optical structure according to an embodiment of the present disclosure, the plurality of film layers of the beam splitting film includes a plurality of metal layers. Since the reflection and transmission of a metal material are insensitive to polarization, the difference between the transmittance of the P-polarized component and the transmittance Ts of the S-polarized component of the incident light is not large when the incident angle of the light incident on the beam splitting film is relatively large (e.g., when the incident angle is greater than 20 degrees). Compared to the medium beam splitting film, the beam splitting film provided with the metal layer can improve the consistency of the transmittance Tp of the P-polarized component and the transmittance Ts of the S-polarized component of the incident light, so that the impact on the ellipticity of the incident light can be reduced, making the ellipticity of the incident light as close as possible to 1. It should be noted that the medium beam splitting film in the present application refers to a beam splitting film that does not include a metal layer.

In the present disclosure, the beam splitting film includes a plurality of film layers, the plurality of film layers includes a plurality of metal layers, and one or more non-metal layers are disposed between two adjacent metal layers of the plurality of metal layers. Thus, Fabry-Perot interference principle of the plurality of metal layers with the non-metal layer therebetween can be combined with the interference principle of the plurality of non-metal layers to design the plurality of film layers of the beam splitting film, enabling the beam splitting film to form a low-reflection band in a set band and reducing the reflectance of the beam splitting film in the set band. For example, the set band may be a near-infrared band, e.g., the set band is around 850 nm or 940 nm. When the optical structure is combined with the eye tracking structure, since the beam splitting film has a relatively low reflectance in this band, the interference of reflection of the beam splitting film in this band on the infrared imaging of the human eye can be reduced, and the accuracy of the eye tracking structure in tracking the human eye can be improved.

In this embodiment, the plurality of metal layers includes a mixed metal layer, the material of the mixed metal layer includes a first metal and a second metal, and the interfacial energy between the first metal and the layer to be deposited in the mixed metal layer is less than the interfacial energy between the second metal and the layer to be deposited. Thus, an affinity between the first metal and the layer to be deposited is stronger than an affinity between the second metal and the layer to be deposited, a bonding force between the first metal and the layer to be deposited is stronger than a bonding force between the second metal and the layer to be deposited, and the first metal can be formed more easily and more uniformly on the layer to be deposited compared to the second metal. It is possible to first form the first metal on the layer to be deposited, so that the first metal is in direct contact with the layer to be deposited, and then form the second metal. Since the first metal can be more easily and more uniformly formed on the layer to be deposited and the affinity and the bonding force between the second metal and the first metal are better than the affinity and the bonding force between the second metal and the layer to be deposited, the subsequently formed second metal based on the first metal can be more easily, more uniformly and more densely formed on the layer to be deposited and the first metal. Further, the bonding force between the mixed metal layer formed and the layer to be deposited is stronger, and the mixed metal layer can be more uniformly and more densely deposited on the layer to be deposited, so that the mixed metal layer may also be a continuous thin film even when the thickness of the mixed metal layer is relatively low, thus reducing a percolation threshold (i.e., the minimum thickness of the mixed metal layer that can form a continuous thin film under set conditions) of the mixed metal layer, and reducing the thickness of the mixed metal layer when it is a continuous film. Thus, the mixed metal layer which is more uniform and denser ensures optical performance of the beam splitting film; and besides, the stronger bonding force between the mixed metal layer and the layer to be deposited ensures stability and reliability of the beam splitting film and avoids oxidization of the mixed metal layer. In addition, because the mixed metal layer has a lower percolation threshold than a pure metal layer, the mixed metal layer has a smaller thickness. In this way, the thickness of each layer of the beam splitting film can be more conveniently adjusted to facilitate the formation of the low-reflection band in the set band.

In the present disclosure, interfacial energy is the energy required for forming an interface between two substances, or the energy released or absorbed when two substances come into contact to form an interface. The lower interfacial energy indicates a higher affinity and a higher bonding force between the two substances, and indicates that at the initial stage of deposition of one substance on a surface of another, the former tends to be more uniformly distributed on the surface of the latter. The higher interfacial energy indicates a weaker affinity between two substances and indicates that at the initial stage of deposition of one substance on the surface of another, the former tends to be aggregated into clusters rather than to be evenly distributed on the surface of the latter. The affinity in the present disclosure is the correlation property between the two substances, and the bonding force is the acting force for mutual bonding between the two substances.

The optical structure and the display apparatus provided in the embodiments of the present disclosure are described in detail below with reference to the accompanying drawings.

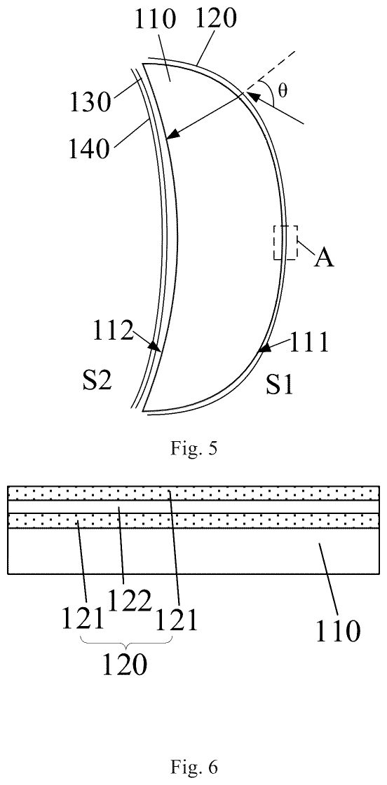

An embodiment of the present disclosure provides an optical structure. FIG. 5 is a sectional view of an optical structure according to an embodiment of the present disclosure; and FIG. 6 is a partially enlarged sectional view of the optical structure shown in FIG. 5. As shown in FIG. 5 and FIG. 6, the optical structure 100 includes a light incident side S1 and a light exit side S2. The optical structure 100 includes a lens structure 110, a beam splitting film 120, a phase retardation film 130 and a reflective polarizing film 140. The lens structure 110 includes a first surface 111 and a second surface 112 disposed opposite each other, the first surface 111 being a surface of the lens structure 110 on the light incident side S1. The beam splitting film 120 is located on a side of the first surface 111 away from the second surface 112; the phase retardation film 130 is located on a side of the second surface 112 away from the first surface 111; and the reflective polarizing film 140 is located on the side of the second surface 112 away from the first surface 111. The beam splitting film 120 includes a plurality of film layers arranged in a stacked manner along a thickness direction of the beam splitting film 120, the plurality of film layers includes a plurality of metal layers 121 and at least one non-metal layer 122, and one or more non-metal layer 122 of the at least one non-metal layer 122 are disposed between two adjacent metal layers 121 of the plurality of metal layers 121. The plurality of metal layers 121 includes a mixed metal layer, the material of the mixed metal layer includes at least two metals, and the at least two metals include a first metal and a second metal. A non-metal layer that is in direct contact with the mixed metal layer and located on a side of the mixed metal layer 122 close to the lens structure 110 is a layer to be deposited, at least part of the first metal of the mixed metal layer is in direct contact with the layer to be deposited, and an interfacial energy between the first metal and the layer to be deposited is less than an interfacial energy between the second metal and the layer to be deposited.

The beam splitting film of the optical structure includes a plurality of film layers, the plurality of metal layers includes a mixed metal layer. Thus, when the incident angle of the light incident on the optical structure is relatively large, the beam splitting film of the optical structure can reduce the impact on the ellipticity of the incident light. Moreover, the beam splitting film has a low reflectance in a set band, enabling the optical structure to be used in combination with an eye tracking structure, and the optical performance of the beam splitting film is more stable and reliable.

In the optical structure provided in the embodiment of the present disclosure, as shown in FIG. 5 and FIG. 6, the plurality of layers of the beam splitting film 120 includes a plurality of metal layers 121. Because the reflection and transmission of the metal material are insensitive to polarization, the difference between the transmittance of a P-polarization component and the transmittance Ts of an S-polarization component of the incident light is not large when the incident angle θ of the light incident on the beam splitting film 120 is relatively large (e.g., when the incident angle θ is greater than 20 degrees). Compared to the medium beam splitting film, the beam splitting film 120 provided with the metal layer 121 can improve the consistency of the transmittance Tp of the P-polarized component and the transmittance Ts of the S-polarized component of the incident light, so that the impact on the ellipticity of the incident light can be reduced, making the ellipticity of the incident light as close as possible to 1. For example, when the incident angle θ of the incident light is 40 degrees, the difference between the transmittance Tp of the P-polarized component and the transmittance Ts of the S-polarized component of the incident light on the beam splitting film 120 is not greater than 20%. It should be noted that the medium beam splitting film in the present application refers to a beam splitting film that does not include a metal layer.

In this embodiment, the beam splitting film includes a plurality of film layers, the plurality of film layers includes a plurality of metal layers, and one or more non-metal layers are disposed between two adjacent metal layers of the plurality of metal layers. Thus, Fabry-Perot interference principle of the plurality of metal layers with the non-metal layer therebetween can be combined with the interference principle of the plurality of non-metal layers to design the plurality of film layers of the beam splitting film, enabling the beam splitting film to form a low-reflection band in a set band and reducing the reflectance of the beam splitting film in the set band. For example, the set band may be a near-infrared band. For example, the set band is in a range from 800 nm to 1500 nm. For example, the set band is around 850 nm or 940 nm. For example, the reflectance corresponding to the low-reflection band is not greater than 10%. When the optical structure is combined with the eye tracking structure, since the beam splitting film has a relatively low reflectance in this band, the interference of reflection of the beam splitting film in this band on the infrared imaging of the human eye can be reduced, and the accuracy of the eye tracking structure in tracking the human eye can be improved.

In this embodiment, the plurality of metal layers includes a mixed metal layer, the material of the mixed metal layer includes a first metal and a second metal, and the interfacial energy between the first metal and the layer to be deposited in the mixed metal layer is less than the interfacial energy between the second metal and the layer to be deposited. Thus, an affinity between the first metal and the layer to be deposited is stronger than an affinity between the second metal and the layer to be deposited, a bonding force between the first metal and the layer to be deposited is stronger than a bonding force between the second metal and the layer to be deposited, and the first metal can be formed more easily and more uniformly on the layer to be deposited compared to the second metal. It is possible to first form the first metal on the layer to be deposited, so that the first metal is in direct contact with the layer to be deposited, and then form the second metal. Since the first metal can be more easily and more uniformly formed on the layer to be deposited and the affinity and the bonding force between the second metal and the first metal are better than the affinity and the bonding force between the second metal and the layer to be deposited, the subsequently formed second metal based on the first metal can be more easily, more uniformly and more densely formed on the layer to be deposited and the first metal. Further, the bonding force between the mixed metal layer formed and the layer to be deposited is stronger, and the mixed metal layer can be more uniformly and more densely deposited on the layer to be deposited, so that the mixed metal layer may also be a continuous thin film even when the thickness of the mixed metal layer is relatively low, thus reducing a percolation threshold (i.e., the minimum thickness of the mixed metal layer that can form a continuous thin film under set conditions) of the mixed metal layer, and reducing the thickness of the mixed metal layer when it is a continuous film. Thus, the mixed metal layer which is more uniform and denser ensures optical performance of the beam splitting film; and besides, the stronger bonding force between the mixed metal layer and the layer to be deposited ensures stability and reliability of the beam splitting film and avoids oxidization of the mixed metal layer. In addition, because the mixed metal layer has a lower percolation threshold than a pure metal layer, the mixed metal layer has a smaller thickness. In this way, the thickness of each layer of the beam splitting film can be more conveniently adjusted to facilitate the formation of the low-reflection band in the set band.

In response to the metal layer including only the second metal, the second metal being formed after the layer to be deposited, due to the relatively large interfacial energy between the second metal and the layer to be deposited, the formed metal layer is of a discontinuous island-like structure. The discontinuous island-like structure not only seriously affects the optical performance of the beam splitting film. Besides, due to the discontinuous island-like structure of the metal layer, the bonding force between the metal layer and the layer to be deposited is poor and the metal layer is susceptible to oxidation in air, affecting the stability and reliability of the beam splitting film.

It should be noted that FIG. 5 illustrates the lens structure 110 including one lens, where the first surface 111 and the second surface 112 of the lens structure 110 are outer surfaces provided opposite each other. However, embodiments of the present disclosure do not impose limitations thereon, and the lens structure may include a plurality of lenses. For example, when the lens structure includes a plurality of lenses, the plurality of lenses includes a plurality of surfaces, and the second surface may be an outer surface of the plurality of surfaces close to the light incident side or a surface of the plurality of surfaces between the two outermost surfaces. For example, when the lens structure includes a plurality of lenses, the first surface and the second surface may be two outer surfaces on the same lens, or may be outer surfaces on different lenses. For example, the lens structure may include two, three, or four lenses, etc. For example, the second surface may be a planar surface or a curved surface. For example, the plurality of lenses of the lens structure may be spaced apart from each other or may be attached together. Embodiments of the present disclosure do not impose limitations on the lens structure. FIG. 5 illustrates the reflective polarizing film 140 located on a side of the phase retardation film 130 away from the lens structure 110. For example, the reflective polarizing film may also be located on a side of the phase retardation film close to the lens structure. FIG. 6 illustrates a partially enlarged sectional view of part A in FIG. 5. It will be appreciated that the structure at other positions on the first surface of the lens structure is the same as that of FIG. 5. The partially enlarged sectional views hereinafter are similar and will not be repeated.

FIG. 6 illustrates the beam splitting film 120 including three film layers, the three film layers being two metal layers 121 and a non-metal layer 122 between the two metal layers 121. However, embodiments of the present disclosure do not impose limitation on the number of film layers included in the beam splitting film, as well as the number of the metal layers and the non-metal layers.

For example, as shown in FIG. 6, any one of the two metal layers 121 is a mixed metal layer. For example, both the metal layers 121 are mixed metal layers.

In some examples, a content of the first metal in the mixed metal layer is not greater than 30%, and the main component of the mixed metal layer is the second metal. For example, the second metal has superior optical performance. For example, a light absorptance of the second metal is less than a light absorptance of the first metal. For example, the metallicity of the first metal is greater than the metallicity of the second metal, and the first metal is more active than the second metal. Since the content of the first metal is not greater than 30%, the mixed metal may have superior optical performance and higher stability.

In some examples, the light absorptance of the second metal is less than the light absorptance of the first metal, and the content of the first metal in the mixed metal layer is not greater than 15%. On the basis of ensuring that the mixed metal layer can be better formed on the layer to be deposited, the light absorptance of the beam splitting film can be reduced by decreasing the content of the first metal and increasing the content of the second metal, so that the beam splitting film has better reflection and transmission performance, ensuring optical efficiency of the optical structure. For example, the visible light absorptance of the second metal is less than the visible light absorptance of the first metal. For example, a wavelength of the visible light is in a range from 380 nm to 780 nm. For example, an absorption of the beam splitting film is not greater than 25%.

Embodiments of the present disclosure do not impose limitations on the content of the first metal of the mixed metal layer. For example, the content may be 1%, 2%, 3%, 4%, 5%, 6%, 7%, 8%, 9%, 10%, 11%, 12%, 13%, 14%, 16%, 18%, etc., which will not be herein in detail.

For example, the material of the mixed metal layer may include only the first metal and the second metal. For example, the content of the first metal is not greater than 30%, the content of the second metal is not less than 70%, and the sum of the contents of the two is 1. For example, the content of the first metal is not greater than 15%, the content of the second metal is not less than 85%, and the sum of the contents of the two is 1.

For example, the material of the mixed metal layer may include multiple types of metals and there are more than two types of metals, the multiple types of metals include the second metal, and metals of the multiple types of metals other than the second metal are other metals. For example, the interfacial energy between the second metal and the layer to be deposited is greater than the interfacial energy between another metal and the layer to be deposited, and the light absorptance of the second metal is less than the light absorptance of the other metal. For example, the content of the other metal is not greater than 30% and the content of the second metal is not less than 70%. For example, the content of the other metal is not greater than 15% and the content of the second metal is not less than 85%.

In some examples, the thickness of the mixed metal layer is in a range from 5 nm to 25 nm. The thickness of the mixed metal layer is controlled to be relatively small, which may facilitate interference of light waves between the plurality of film layers of the mixed metal layer such that the low-reflection band can be formed more easily in a set band. Embodiments of the present disclosure do not impose limitations on the thickness of the mixed metal layer. For example, the thickness of the mixed metal layer is 5.5 nm, 6 nm, 6.5 nm, 7 nm, 7.5 nm, 8 nm, 8.5 nm, 9 nm, 9.5 nm, 10 nm, 10.5 nm, 11 nm, 11.5 nm, 12 nm, 12.5 nm, 13 nm, 13.5 nm, 14 nm, 14.5 nm, 15 nm, 16 nm, 17 nm, 18 nm, 19 nm, 20 nm, 21 nm, 22 nm, 23 nm, 24 nm, etc., which will not be herein in detail.

In some examples, the first metal is one selected from the group consisting of aluminum (Al), nickel (Ni), chromium (Cr), zinc (Zn), copper (Cu), gold (Au), titanium (Ti), indium (In) and germanium (Ge), and the second metal is silver (Ag). Compared to the first metal described above, when the second metal is silver that has a lowest light absorptance, the light absorptance of the beam splitting film can be reduced, and the beam splitting film has better reflection and transmission performance. Of course, embodiments of the present disclosure do not impose limitations on the type of metals of the mixed metal layer.

For example, the mixed metal layer includes multiple types of metals and there are more than two types of metals. For example, the most abundant metal in a mixed metal layer 1210 is silver, and the remaining metals are at least one selected from the group consisting of aluminum (Al), nickel (Ni), chromium (Cr), zinc (Zn), copper (Cu), gold (Au), titanium (Ti), indium (In), and germanium (Ge).

In some examples, the material of the non-metal layer may be transparent oxides. For example, the transparent oxides include, but are not limited to, silicon dioxide (SiO₂), silicon monoxide (SiO), titanium dioxide (TiO₂), aluminum trioxide (Al₂O₃), niobium pentoxide (Nb₂O₅), zirconium dioxide (ZrO₂), tantalum pentoxide (Ta₂O₅), cerium dioxide (CeO₂), hafnium dioxide (HfO₂), lanthanum sesquioxide (La₂O₃), zinc oxide (ZnO), tin dioxide (SnO₂), and polyoxides based on these oxides. For example, the material of the non-metal layer may be transparent nitrides, sulfides, and fluorides. For example, the material of the non-metal layer may be silicon nitride (Si₃N₄), zinc sulfide (ZnS), magnesium fluoride (MgF₂), etc. For example, the material of the non-metal layer may be metal-doped transparent oxides. For example, the material of the non-metal layer may be indium tin oxide (ITO), aluminum-doped zinc oxide (AZO), fluorine-doped tin oxide (FTO), etc. Of course, embodiments of the present disclosure do not impose limitations on the material of the non-metal layer.

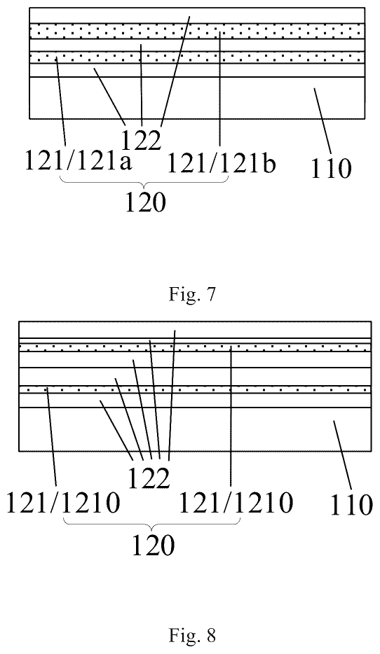

FIG. 7 is another partially enlarged sectional view of the optical structure shown in FIG. 5. As shown in FIG. 5 and FIG. 7, the beam splitting film 120 includes a plurality of non-metal layers 122 and a plurality of metal layers 121, and the plurality of metal layers 121 includes a nearest metal layer 121a closest to the lens structure 110 and a farthest metal layer 121b farthest away from the lens structure 110. At least one layer of the plurality of non-metal layers 122 is disposed between the nearest metal layer 121a and the lens structure 110, and at least one layer of the plurality of non-metal layers 122 is disposed on a side of the farthest metal layer 121b away from the lens structure 110. A bonding force between the non-metal layers 122 and the lens structure 110 is greater than a bonding force between the metal layers 121 and the lens structure 110. Since the non-metal layer 122 is disposed between the nearest metal layer 121a and the lens structure 110, the beam splitting film 120 can be more uniformly and more stably formed on the lens structure 110. Since the non-metal layer 122 is disposed on the side of the farthest metal layer 121b away from the lens structure 110, the non-metal layers 122 can protect the metal layers 121 and prevent the metal material of the metal layers 121 from oxidizing, thus ensuring the optical performance of the beam splitting film 120. In addition, the plurality of non-metal layers 122 and the plurality of metal layers 121 are provided to help to regulate interference of light wave between the plurality of film layers, thereby facilitating the formation of the low-reflection band in a set band.

FIG. 7 illustrates the beam splitting film 120 including five film layers, the five film layers including two metal layers 121 and three non-metal layers 122. However, embodiments of the present disclose do not impose limitations on the number of the metal layers included in the beam splitting film, the number of the non-metal layers between the nearest metal layer and the lens structure, the number of the non-metal layers between adjacent metal layers, or the number of the non-metal layers on the side of the farthest metal layer away from the lens structure.

For example, as shown in FIG. 7, any one of the two metal layers 121 is a mixed metal layer. For example, both the metal layers 121 are mixed metal layers.

In some examples, the mixed metal layer of the beam splitting film of the optical structure includes a first-type mixed metal layer, the first metal of the first-type mixed metal layer is doped in the second metal.

For example, as shown in FIG. 6 and FIG. 7, any one of the two metal layers 121 is the first-type mixed metal layer. For example, both the metal layers 121 are the first-type mixed metal layers.

For example, the first-type mixed metal layer includes multiple types of metals, and there are more than two types of metals, the metal with the highest content is the second metal, and metals other than the second metal in the multiple types of metals are doped in the second metal.

In some examples, the first-type mixed metal layer includes a first mixed metal layer, the first metal of the first mixed metal layer is uniformly doped in the second metal. For example, the mixed metal layer may be formed by a process of evaporative coating, whereby the uniformly doped first mixed metal layer can be obtained by keeping deposition rate of the first metal material constant with deposition rate of the second metal material. For example, the preparation process of the first mixed metal layer is simplified, and accordingly the performance stability and consistency of the beam splitting film are higher.

For example, the first mixed metal layer includes multiple types of metals and there are more than two types of metals. The metal with the highest content is the second metal, and metals other than the second metal of the multiple types of metals are uniformly doped in the second metal.

In some examples, the first-type mixed metal layer includes a second mixed metal layer, along a thickness direction of the second mixed metal layer, a ratio of the first metal to the second metal of the second mixed metal layer is variable, i.e., the first metal is not uniformly doped in the second mixed metal layer. For example, the ratio of the first metal to the second metal may be a ratio of the content of the first metal to the content of the second metal per unit thickness. For example, the ratio of the first metal to the second metal may also be a ratio of the mass of the first metal to the mass of the second metal per unit thickness. For example, by adjusting the ratio of the first metal to the second metal in the thickness direction, the bonding force and affinity between the mixed metal layer and the non-metal layer of the beam splitting film can be improved, and the optical performance of the beam splitting film can also be changed to obtain the desired beam splitting film.

For example, in a thickness direction of the second mixed metal layer and away from the lens structure, the ratio of the first metal to the second metal first decreases and then increases. For example, at both sides of the second mixed metal layer along the thickness direction, the ratio of the first metal to the second metal is relatively large. In the middle of the second mixed metal layer along the thickness direction, the ratio of the first metal to the second metal is relatively small. By increasing the ratio of the first metal to the second metal at both sides of the second mixed metal layer along the thickness direction, the content of the first metal in direct contact with the non-metal layer can be increased, and accordingly, the bonding force and affinity between the second mixed metal layer and the non-metal layer can be increased, and the second mixed metal layer has more reliable and stable performance. Further, by reducing the ratio of the first metal to the second metal in the middle of the second mixed metal layer along the thickness direction, the content of the first metal in the middle can be reduced while the content of the second metal in the middle can be increased. On the premise of not affecting the film-forming quality of the second mixed metal layer and the performance of the beam splitting film, the light absorptance of the beam splitting film can be reduced by minimizing the content of the first metal and increasing the content of the second metal of the second mixed metal layer, so that the beam splitting film has better reflection and transmission performance.

In some examples, the mixed metal layer includes a second-type mixed metal layer, the second-type mixed metal layer includes a plurality of sublayers arranged in a stacked manner, the plurality of sublayers includes a nearest sublayer closest to the lens structure, and the material of the nearest sublayer includes the first metal. In this embodiment, the material of the nearest sublayer includes the first metal, which is conducive to reducing the content of the first metal in another sublayer, and accordingly, the content of the first metal of the second-type mixed metal layer can be minimized while the content of the second metal can be maximized, so that the light absorptance of the beam splitting film 120 can be reduced and the beam splitting film has better reflection and transmission performance.

For example, the content of the first metal of the nearest sublayer of the second-type mixed metal layer is greater than the content of the first metal of the other sublayer.

For example, as shown in FIG. 6 and FIG. 7, any one of the two metal layers 121 is the second-type mixed metal layer. For example, both the metal layers 121 are the second-type mixed metal layers.

In some examples, the second-type mixed metal layer includes a third mixed metal layer, the third mixed metal layer includes a plurality of sublayers, the plurality of sublayers includes a nearest sublayer closest to the lens structure, the material of the nearest sublayer is the first metal, and the material of each sublayer of the plurality of sublayers other than the nearest sublayer is the second metal. Thus, since the material of only the nearest sublayer of the plurality of sublayers of the third mixed metal layer includes the first metal, and the material of the other sublayers does not include the first metal, the content of the first metal in the third mixed metal layer can be minimized, so that the beam splitting film has better reflection and transmission performance.

For example, the third mixed metal layer includes multiple types of metals and there are more than two types of metals. The metal with the highest content is the second metal, and the material of the nearest layer only includes metals other than the second metal of the multiple types of metals. For example, all of the metals other than the second metal are disposed in the nearest sublayer.

For example, a thickness of the nearest sublayer is not greater than 2 nm. For example, the thickness of the nearest sublayer may be 0.5 nm, 1 nm, 1.5 nm, or 2 nm. For example, the sum of thicknesses of the sublayers other than the nearest sublayer of the third mixed metal layer is not greater than 13 nm. For example, the sum of thicknesses is 5 nm, 5.5 nm, 6 nm, 6.5 nm, 7 nm, 7.5 nm, 8 nm, 8.5 nm, 9 nm, 9.5 nm, 10 nm, 10.5 nm, 11 nm, 11.5 nm, 12 nm, 12.5 nm, 13 nm, etc. By minimizing the thickness of the nearest sublayer, the content of the first metal can be reduced and the thickness of the mixed metal layer can be minimized. The thickness of the mixed metal layer can be minimized by minimizing the thickness of the other sublayers other than the nearest sublayer.

At the initial stage of the formation of a certain content of metal on the layer to be deposited, the metal may be in the form of aggregated particles in an aggregated state. The aggregated particles include a plurality of metal particles. Since the interfacial energy between the first metal and the layer to be deposited is smaller than the interfacial energy between the second metal and the layer to be deposited, the aggregated particles in the aggregated state formed on the layer to be deposited at the initial stage of the formation of the same content of the first metal are smaller in size, wider in distribution, and higher in content compared to the same content of the second metal. Thus, the same content of the first metal can be more densely and firmly distributed on the layer to be deposited than the same content of the second metal. On this basis, the post-formed metal can be more densely and more firmly formed on the layer to be deposited, whereby the mixed metal layer can be formed into a continuous film layer earlier and the thickness of the mixed metal layer is smaller when the mixed metal layer is a continuous film layer.

In some examples, when the material of the nearest sublayer is the first metal, the material of the nearest sublayer can be more densely and more firmly distributed on the layer to be deposited; and on the basis of the nearest sublayer, another sublayer can be more densely and more firmly formed on the layer to be deposited, so that the mixed metal layer can be formed into a continuous film layer earlier, the mixed metal layer has a smaller thickness, the bonding force between the mixed metal layer and the layer to be deposited is larger, and the performance of the beam splitting film is more stable and reliable.

In some examples, a material of a non-metal layer in direct contact with the nearest sublayer is an oxide of the first metal. In this way, the interfacial energy between the first metal and the non-metal layer can be reduced, and the affinity and bonding force between the first metal and the non-metal layer can be increased.

In some examples, the second-type mixed metal layer includes a fourth mixed metal layer, the fourth mixed metal layer includes a plurality of sublayers, the plurality of sublayers includes a nearest sublayer closest to the lens structure, the material of the nearest sublayer includes the first metal and the second metal, and the content of the first metal of the nearest layer is not greater than 30%. In the examples, the content of the first metal of the fourth mixed metal layer can be minimized while the content of the second metal can be maximized, so that the light absorptance of the beam splitting film can be reduced and the beam splitting film has better reflection and transmission performance.

For example, the fourth mixed metal layer includes multiple types of metals and there are more than two types of metals. The metal with the highest content is the second metal, and the material of the nearest sublayer includes the multiple types of metals. For example, all metals other than the second metal are disposed in the nearest sublayer.

Embodiments of the present disclosure do not impose limitations on the content of the first metal of the nearest sublayer of the second-type mixed metal layer, for example, the content may be 1%, 2%, 3%, 4%, 5%, 6%, 7%, 8%, 9%, 10%, 11%, 12%, 13%, 14%, 16%, 18%, etc., which will not be herein in detail.

In some examples, the material of other sublayers of the plurality of sublayers of the fourth mixed metal layer other than the nearest sublayer is the second metal. In this way, it is conducive to minimizing the content of the first metal of the fourth mixed metal layer, enabling the beam splitting film to have better reflection and transmission performance.

In some examples, the plurality of sublayers of the fourth mixed metal layer further includes a farthest sublayer farthest away from the lens structure, the material of the farthest sublayer includes the first metal and the second metal, the content of the first metal of the farthest sublayer is not greater than 30%, and the material of another sublayer of the plurality of sublayers other than the nearest sublayer and the farthest sublayer is the second metal. For example, when the material of the farthest sublayer includes the first metal, the bonding force and affinity between the fourth mixed metal layer and the non-metal layer can also be increased.

In some examples, as shown in FIG. 6 and FIG. 7, at least one metal layer of the plurality of metal layers 121 of the beam splitting film 120 is the mixed metal layer, and the mixed metal layer may be at least one selected from the group consisting of the first-type mixed metal layer and the second-type mixed metal layer. For example, the mixed metal layer may be at least one selected from the group consisting of the first mixed metal layer, the second mixed metal layer, the third mixed metal layer, and the fourth mixed metal layer.

For example, the plurality of metal layers of the beam splitting film may all be mixed metal layers. For example, some of the metal layers of the plurality of metal layers of the beam splitting film may be a single metal layer. For example, the material of the single metal layer is the second metal. For example, the thickness of the single metal layer is greater than a percolation threshold of the second metal so that the single metal layer may be a continuous film layer, bringing the beam splitting film better optical performance and better stability and reliability.

FIG. 8 is another partially enlarged sectional view of the optical structure shown in FIG. 5. As shown in FIG. 8, the beam splitting film 120 of the optical structure includes a titanium dioxide (TiO₂) layer, a silver-aluminum alloy (Ag—Al) layer, an aluminum trioxide (Al₂O₃) layer, a titanium dioxide (TiO₂) layer, a silver-aluminum alloy (Ag—Al) layer, an aluminum trioxide (Al₂O₃) layer, and a silicon dioxide (SiO₂) layer formed in sequence on the lens structure 110, and thicknesses of the respective film layers are 19.43 nm, 9.627 nm, 73.89 nm, 66.112 nm, 13.925 nm, 0.7 nm, and 81.552 nm, respectively.

The two metal layers 121 of the example beam splitting film 120 are both mixed metal layers 1210. For example, both the metal layers 121 are the first-type mixed metal layers. For example, the first metal in the mixed metal layer is aluminum and the second metal is silver. Two non-metal layers 122 are included between two adjacent metal layers 121, and the two non-metal layers 122 are disposed on a side, away from the lens structure 110, of the metal layer 121 farthest away from the lens structure 110. Of course, embodiments of the present disclosure do not impose limitations on the number and material, etc. of the metal layer and non-metal layer.

For example, both the metal layers 121 are the first mixed metal layers of the first-type mixed metal layers. For example, the content of the first metal in the first mixed metal layer is 5%. For example, the thickness of the first mixed metal layer is about 9.6 nm and 13.9 nm. Of course, embodiments of the present disclosure do not impose limitations on the type, thickness, etc. of the metal layers. For example, any of the metal layers of the example beam splitting film may also be the second mixed metal layer of the first-type mixed metal layer.

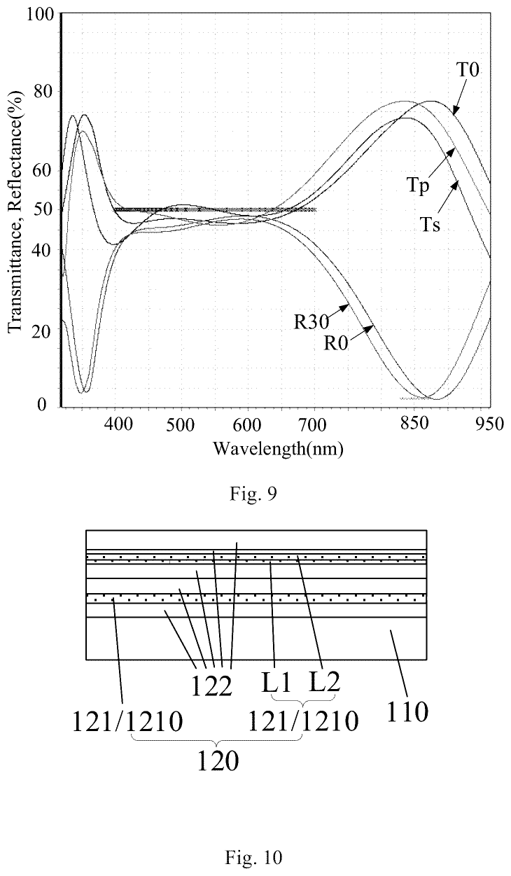

FIG. 9 is a curve chart of reflectance and transmittance of light incident at different incident angles on the beam splitting film shown in FIG. 8. The figure shows reflectance R0 and transmittance T0 of the incident light at an incident angle of 0 degrees, reflectance R30 of the incident light at an incident angle of 30 degrees, and transmittance Ts of an S-polarized component and transmittance Tp of a P-polarized component of the incident light at an incident angle of 40 degrees.

As shown in FIG. 9, the transmittance Ts of the S-polarized component and the transmittance Tp of the P-polarized component of the incident light at an incident angle of 40 degrees are basically equal to target values (the target values are both 50%) in a wavelength range of 450 nm to 700 nm, and the difference between the transmittance Ts of the S-polarized component and the transmittance Tp of the P-polarized component is relatively small, which is not greater than 10%. At an incident angle of 30 degrees, the reflectance of the incident light is not greater than 5% at a wavelength of 850 nm. Thus, in response to a relatively large incident angle of the light incident on the beam splitting film, the beam splitting film can reduce the impact on the ellipticity of the incident light, and the reflectance of the light is very low in a set band, and accordingly, the beam splitting film can have the advantages of near-infrared low reflection and depolarized transmission of visible light.

FIG. 10 is another partially enlarged sectional view of the optical structure shown in FIG. 5. As shown in FIG. 10, the beam splitting film 120 of the optical structure includes a titanium dioxide (TiO₂) layer, a silver-aluminum alloy (Ag—Al) layer, a silicon dioxide (SiO₂) layer, a titanium dioxide (TiO₂) layer, an aluminum (Al) layer, a silver (Ag) layer, a titanium dioxide (TiO₂) layer, and a silicon dioxide (SiO₂) layer formed on the lens structure 110 in sequence, and the thicknesses of the respective film layers are 15.829 nm, 8.421 nm, 86.168 nm, 66.984 nm, 0.5 nm, 12.682 nm, 0.5 nm, and 77.002 nm, respectively.

The two metal layers 121 of the example beam splitting film 120 are both mixed metal layers 1210. For example, the mixed metal layer 1210 closest to the lens structure 110 is the first-type mixed metal layer. For example, the mixed metal layer 1210 closest to the lens structure 110 may be the first mixed metal layer of the first-type mixed metal layer, where the first metal of the first mixed metal layer is aluminum and the second metal thereof is silver. For example, the content of the first metal of the first mixed metal layer is 2%.

For example, the mixed metal layer 1210 farthest from the lens structure 110 is the second-type mixed metal layer. For example, the mixed metal layer 1210 farthest from the lens structure 110 is the third mixed metal layer of the second-type mixed metal layer, the third mixed metal layer includes two sublayers L1 and L2, which are, for example, an aluminum (Al) layer and a silver (Ag) layer, where the aluminum (Al) layer is the nearest sublayer. For example, a thickness of the sublayer L1 is 0.5 nm and a thickness of the sublayer L2 is about 12.6 nm.

The nearest sublayer in this example is uniformly distributed on the layer to be deposited. On the basis of the nearest sublayer, silver can be deposited more easily, more uniformly and more densely on the layer to be deposited, so that there are better affinity and bonding force between the third mixed metal layer and the layer to be deposited, and the third mixed metal layer can be formed into a continuous film, improving the adhesion and density of the silver in the third mixed metal layer. For example, when the thickness of the nearest sublayer is 0.5 nm, the nearest sublayer includes fine and dispersed particles.

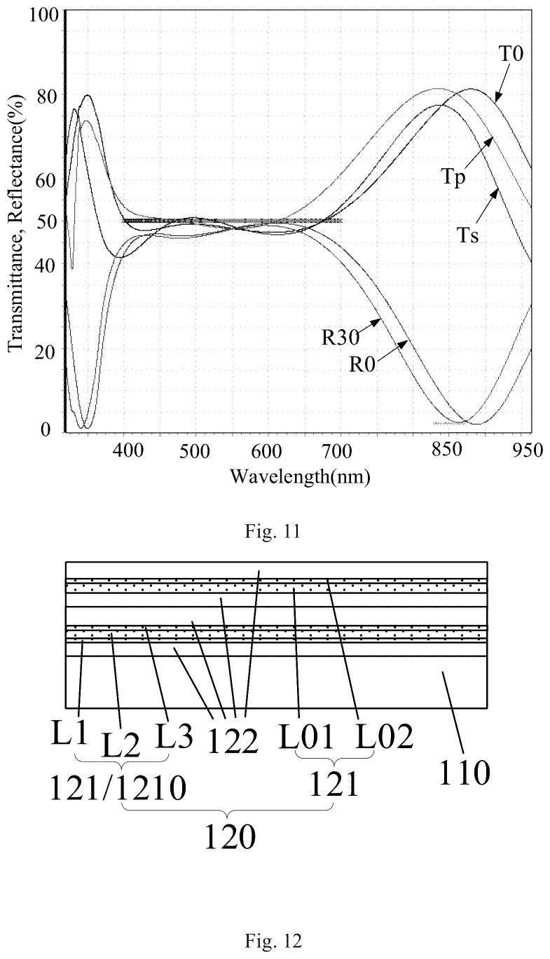

FIG. 11 is a curve chart of reflectance and transmittance of light incident at different incident angles on the beam splitting film shown in FIG. 10. The figure shows reflectance R0 and transmittance T0 of the incident light at an incident angle of 0 degrees, reflectance R30 of the incident light at an incident angle of 30 degrees, and transmittance Ts of an S-polarized component and transmittance Tp of a P-polarized component of the incident light at an incident angle of 40 degrees.

As shown in FIG. 11, the transmittance Ts of the S-polarized component and the transmittance Tp of the P-polarized component of the incident light at an incident angle of 40 degrees are basically equal to target values (the target values are both 50%) in a wavelength range of 450 nm to 700 nm, and the difference between the transmittance Ts of the S-polarized component and the transmittance Tp of the P-polarized component is relatively small. At an incident angle of 30 degrees, the reflectance of the incident light is not greater than 5% at a wavelength of 850 nm. Thus, in response to a relatively large incident angle of the light incident on the beam splitting film, the beam splitting film can reduce the impact on the ellipticity of the incident light, and the reflectance of the light is very low in a set band.

FIG. 12 is another partially enlarged sectional view of the optical structure shown in FIG. 5. As shown in FIG. 12, the beam splitting film 120 of the optical structure includes a titanium dioxide (TiO₂) layer, a silver-aluminum alloy (Ag—Al) layer, a silver (Ag) layer, a silver-aluminum alloy (Ag—Al) layer, a silicon dioxide (SiO₂) layer, a titanium dioxide (TiO₂) layer, a silver (Ag) layer, a silver-aluminum alloy (Ag—Al) layer, and a silicon dioxide (SiO₂) layer formed on the lens structure 110 in sequence. The thicknesses of the respective film layer are 16.474 nm, 1 nm, 6.105 nm, 1 nm, 85.599 nm, 67.634 nm, 12.912 nm, 1 nm, 77.438 nm, respectively.

The metal layer 121 of the example beam splitting film 120 that is closest to the lens structure 110 is the mixed metal layer 1210. For example, the mixed metal layer 1210 may be the second-type mixed metal layer. For example, the mixed metal layer 1210 may be the fourth mixed metal layer of the second-type mixed metal layer, the fourth mixed metal layer includes three sublayers, the three sublayers are a nearest sublayer L1, a farthest sublayer L3, and an intermediate sublayer L2 between the nearest sublayer L1 and the farthest sublayer L3. For example, the material of the nearest sublayer L1 includes the first metal and the second metal, the material of the farthest sublayer L3 includes the first metal and the second metal, and the material of the intermediate sublayer L2 is silver. For example, the nearest sublayer L1 and the farthest sublayer L3 are both silver-aluminum alloy (Ag—Al) layers, and the intermediate sublayer L2 is a silver (Ag) layer. For example, the content of the first metal in the nearest sublayer L1 is 2% and the content of the first metal in the farthest sublayer L3 is 5%. For example, both the nearest sublayer L1 and the farthest sublayer L3 have a thickness of 1 nm. For example, a thickness of the intermediate sublayer L2 is about 6 nm. Embodiments of the present disclosure do not impose limitations on the thicknesses of the plurality of sublayers of the fourth mixed metal layer.

The metal layer 121 farthest away from the lens structure 110 of the example beam splitting film 120 includes a silver layer L01 and a silver-aluminum alloy layer L02, and the total thickness of the silver layer L01 and the silver-aluminum alloy layer L02 is nearly 14 nm, which basically satisfies the percolation threshold of silver, such that the metal layer 121 is presented as a continuous film. For example, the content of aluminum in the silver-aluminum alloy layer of the metal layer 121 is 2%.

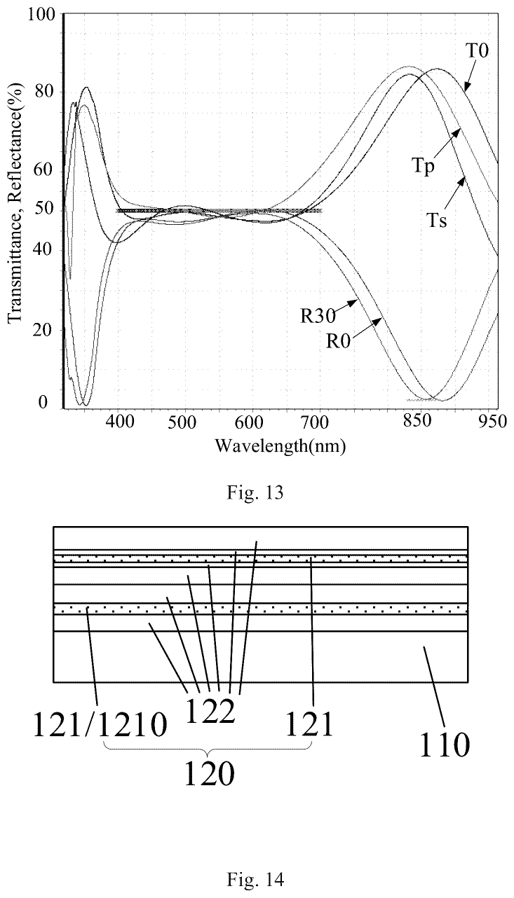

FIG. 13 is a curve chart of reflectance and transmittance of light incident at different incident angles on the beam splitting film shown in FIG. 12. The figure shows reflectance R0 and transmittance T0 of the incident light at an incident angle of 0 degrees, reflectance R30 of the incident light at an incident angle of 30 degrees, and transmittance Ts of an S-polarized component and transmittance Tp of a P-polarized component of the incident light at an incident angle of 40 degrees.

As shown in FIG. 13, the transmittance Ts of the S-polarized component and the transmittance Tp of the P-polarized component of the incident light at an incident angle of 40 degrees are basically equal to target values (the target values are both 50%) in a wavelength range of 450b nm to 700 nm, and the difference between the transmittance Ts of the S-polarized component and the transmittance Tp of the P-polarized component is relatively small. At an incident angle of 30 degrees, the reflectance of the incident light is not greater than 5% at a wavelength of 850 nm. Thus, in response to a relatively large incident angle of the light incident on the beam splitting film, the beam splitting film can reduce the impact on the ellipticity of the incident light, and the reflectance of the light is very low in a set band.

FIG. 14 is another partially enlarged sectional view of the optical structure shown in FIG. 6. As shown in FIG. 14, the beam splitting film 120 of the optical structure includes a titanium dioxide (TiO₂) layer, a silver-zinc alloy (Ag—Zn) layer, a silicon dioxide (SiO₂) layer, a titanium dioxide (TiO₂) layer, a zinc oxide (ZnO) layer, a silver (Ag) layer, a zinc oxide (ZnO) layer, and a silicon dioxide (SiO₂) layer formed on the lens structure 110 in sequence. The thicknesses of the respective film layers are 15.742 nm, 8.349 nm, 85.44 nm, 66.776 nm, 1 nm, 13.502 nm, 0.5 nm, and 76.669 nm, respectively.

The metal layer 121 of the example beam splitting film 120 that is closest to the lens structure 110 is the mixed metal layer 1210. For example, the mixed metal layer 1210 is the first-type mixed metal layer. For example, the mixed metal layer 1210 may be the first mixed metal layer of the first-type mixed metal layer. For example, the first metal in the first mixed metal layer is zinc, and the second metal is silver. For example, the content of the first metal in the first mixed metal layer is 1%. For example, a thickness of the first mixed metal layer is about 8.3 nm.

The metal layer 121 farthest away from the lens structure 110 of the example beam splitting film 120 is a silver layer, and zinc oxide layers are further disposed on both sides along the thickness direction thereof to reduce the percolation threshold of the metal layer 121, so that the metal layer 121 is presented as a continuous film as much as possible.

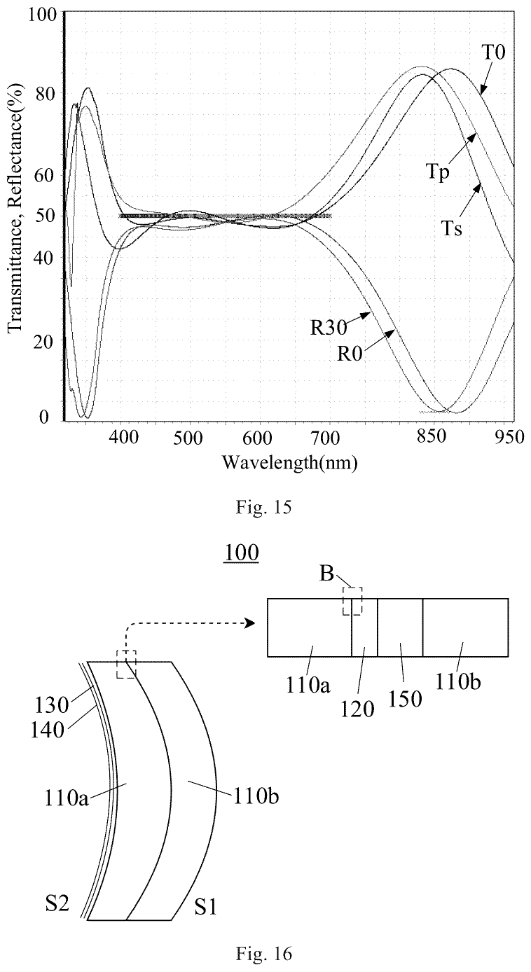

FIG. 15 is a curve chart of reflectance and transmittance of light incident at different incident angles on the beam splitting film shown in FIG. 14. The figure shows reflectance R0 and transmittance T0 of the incident light at an incident angle of 0 degrees, reflectance R30 of the incident light at an incident angle of 30 degrees, and transmittance Ts of an S-polarized component and transmittance Tp of a P-polarized component of the incident light at an incident angle of 40 degrees.

As shown in FIG. 15, the transmittance Ts of the S-polarized component and the transmittance Tp of the P-polarized component of the incident light at an incident angle of 40 degrees are basically equal to target values (the target values are both 50%) in a wavelength range of 450 nm to 700 nm, and the difference between the transmittance Ts of the S-polarized component and the transmittance Tp of the P-polarized component is relatively small. At an incident angle of 30 degrees, the reflectance of the incident light is not greater than 5% at a wavelength of 850 nm. Thus, in response to a relatively large incident angle of the light incident on the beam splitting film, the beam splitting film can reduce the impact on the ellipticity of the incident light, and the reflectance of the light is very low in a set band.

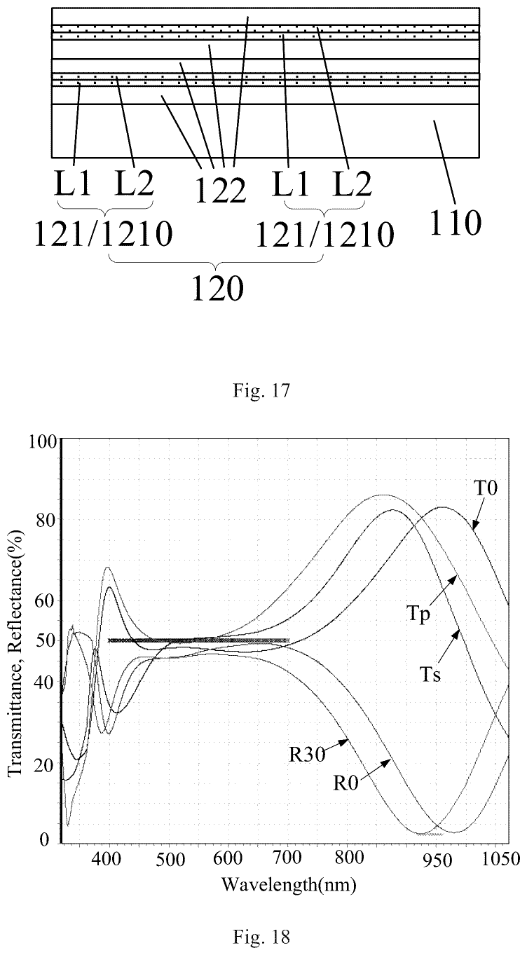

FIG. 16 is a sectional view of an optical structure according to an embodiment of the present disclosure; and FIG. 17 is a partially enlarged sectional view of the optical structure shown in FIG. 16 at position B. As shown in FIG. 16, the lens structure of the optical structure 100 includes a first lens 110a and a second lens 110b, and a beam splitting film 120 is located between the first lens 110a and the second lens 110b. For example, the first lens 110a and the second lens 110b are bonded together by means of an optical adhesive 150.

As shown in FIG. 17, the beam splitting film 120 of the optical structure 100 includes a titanium dioxide (TiO₂) layer, a silver-titanium alloy (Ag—Ti) layer, a silver (Ag) layer, a zinc oxide (ZnO) layer, a titanium dioxide (TiO₂) layer, a silver-copper alloy (Ag—Cu) layer, a silver (Ag) layer, and a titanium dioxide (TiO₂) layer formed on the lens structure 110 in sequence. The thicknesses of the respective film layers are 51.445 nm, 6.5 nm, 7.372 nm, 30.48 nm, 111.035 nm, 2.5 nm, 7.546 nm, and 30.681 nm, respectively.

The two metal layers 121 of the example beam splitting film 120 are both mixed metal layers 1210.

For example, the mixed metal layer 1210 closest to the lens structure 110 is the second-type mixed metal layer. For example, the mixed metal layer 1210 is the fourth mixed metal layer of the second-type mixed metal layer, and the fourth mixed metal layer includes two sublayers L1 and L2. For example, the sublayer L1 is a nearest sublayer, and the material of the nearest sublayer includes the first metal and the second metal, the first metal being titanium and the second metal being silver. For example, the material of the layer to be deposited corresponding to the fourth mixed metal layer is an oxide of the first metal, i.e., titanium dioxide. For example, the content of the first metal in the nearest sublayer is 1%.

For example, the mixed metal layer 1210 farthest from the lens structure 110 is the second-type mixed metal layer. For example, the mixed metal layer 1210 is the fourth mixed metal layer of the second-type mixed metal layer, and the fourth mixed metal layer includes two sublayers L1 and L2. For example, the sublayer L1 is a nearest sublayer, and the material of the nearest sublayer includes the first metal and the second metal, the first metal being copper and the second metal being silver. For example, the content of the first metal in the nearest sublayer is 1%.

FIG. 18 is a curve chart of reflectance and transmittance of light incident at different incident angles on the beam splitting film shown in FIG. 16. The figure shows reflectance R0 and transmittance T0 of the incident light at an incident angle of 0 degrees, reflectance R30 of the incident light at an incident angle of 30 degrees, and transmittance Ts of an S-polarized component and transmittance Tp of a P-polarized component of the incident light at an incident angle of 40 degrees.

As shown in FIG. 18, the transmittance Ts of the S-polarized component and the transmittance Tp of the P-polarized component of the incident light at an incident angle of 40 degrees are basically equal to target values (the target values are both 50%) in a wavelength range of 450 nm to 700 nm, and the difference between the transmittance Ts of the S-polarized component and the transmittance Tp of the P-polarized component is relatively small. At an incident angle of 30 degrees, the reflectance of the incident light is not greater than 5% at a wavelength of 940 nm. Thus, in response to a relatively large incident angle of the light incident on the beam splitting film, the beam splitting film can reduce the impact on the ellipticity of the incident light, and the reflectance of the light is very low in a set band.

In some examples, the film layers of the beam splitting film may be deposited by ion-assisted evaporation coating, and the thicknesses of the respective layers may be controlled by an on-line quartz crystal oscillator sensor. For example, the mixed metal layer may be obtained by evaporating different metal materials. For example, the material of the mixed metal layer includes a first metal and a second metal. The first metal material and the second metal material are placed in two evaporation sources, respectively. The mixed metal layer is obtained by controlling the evaporation source for the first metal material and the evaporation source for the second metal material respectively. For example, the first mixed metal layer can be obtained by evaporating the first metal material and the second metal material simultaneously while keeping deposition rate of the evaporation source for the first metal material and deposition rate of the evaporation source for the second metal material remain unchanged. For example, the second mixed metal layer can be obtained by evaporating the first metal material and the second metal material simultaneously when the deposition rate of the evaporation source for the first metal material or the deposition rate of the evaporation source for the second metal material varies with the thickness. For example, the third mixed metal layer can be obtained when the evaporation source for the first metal material and the evaporation source for the second metal material are not turned on simultaneously. For example, the fourth mixed metal layer can be obtained by evaporating the first metal material and the second metal material simultaneously at the beginning and then evaporating the second metal material only. For example, the fourth mixed metal layer can also be obtained by evaporating the first metal material and the second metal material simultaneously at the beginning and at the end, and evaporating only the second metal material in the intermediate process.

In some examples, the respective layers of the beam splitting film may be deposited by sputtering, etc. For example, the mixed metal layer can be obtained by simultaneously sputtering different metal target materials. For example, the material of the mixed metal layer includes a first metal and a second metal. The mixed metal layer is obtained by sputtering a first metal target material and a second metal target material respectively while controlling the sputtering rate. For example, the mixed metal layer can also be obtained by sputtering an alloy target.

In some examples, the optical structure further includes a light-transmitting undercoat, and the light-transmitting undercoat is in direct contact with the lens structure and located on a side of the lens structure close to the beam splitting film. The material of the light-transmitting undercoat includes an acrylic coating, an organosilicon coating, a polyurethane coating, an amino resin coating, etc. Embodiments of the present disclosure do not impose limitations on the material of the light-transmitting undercoat.

In the example, the affinity and bonding force between the non-metal layer of the beam splitting film and the light-transmitting undercoat are greater than the affinity and bonding force between the non-metal layer of the beam splitting film and the lens structure, so that the beam splitting film can be more stably formed on the light-transmitting undercoat and the lens structure, thus improving the stability and reliability of the beam splitting film.

In some examples, at least one layer of the light-transmissive undercoat is formed on the surface of the lens structure using a wet coating process before forming the beam splitting film on the lens structure. For example, the wet coating process includes dip coating, flow coating, inkjet printing, electrohydrodynamic printing, ultrasonic atomization spray coating, etc.

In some examples, the optical structure further includes a protective layer on a side of the beam splitting film away from the lens structure. For example, the protective layer may be in direct contact with the beam splitting film. For example, the material of the protective layer includes silanes and silanols. For example, the protective layer may be a hydrophobic and oleophobic agent such as perfluoropolyether silanes. The protective layer can protect the beam splitting film, thereby improving the stability and reliability of the beam splitting film.

In some examples, the material of the lens structure includes a cyclic olefin copolymer (COC). For example, the material of the lens structure includes polymethyl methacrylate (PMMA). For example, the material of the lens structure includes glass.

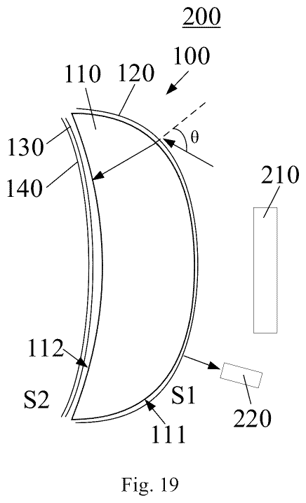

An embodiment of the present disclosure provides a display apparatus. FIG. 19 is a sectional view of a display apparatus according to an embodiment of the present disclosure. As shown in FIG. 19, the display apparatus 200 includes a display screen 210 and any of the optical structures 100 described above, the display screen 210 is located on the light incident side S1 of the optical structure 100. In this way, the display apparatus 200 has the beneficial effect corresponding to the beneficial effect of the optical structure 100, which will not be herein in detail.

In some examples, as shown in FIG. 19, the display screen 210 includes a micro organic light emitting diode display (micro OLED) screen. When the display screen is the micro organic light emitting diode display (micro OLED) screen, the maximum incident angle θ at which light emitted from the display screen 210 is incident to the beam splitting film 120 is relatively large, for example, the incident angle θ is greater than 20 degrees, the consistency of the transmittance of the P-polarized component and the transmittance Ts of the S-polarized component of the incident light can be improved through the optical structure 100 described above. The details are described in the previous section and will not be repeated here.

For example, a size of the micro organic light emitting diode display screen is between 0.8 inches and 1.6 inches. For example, a diameter of the lens of the lens structure 110 is 4 cm to 5 cm. For example, a ratio of a diameter of the lens of the lens structure 110 to a diagonal dimension of the display screen 210 is greater than or equal to 1.5.

In some examples, as shown in FIG. 19, the display apparatus further includes a tracking structure 220 located on the light incident side S1 of the optical structure 100. The tracking structure 220 is configured to receive light within a set band exited from the optical structure 100. The light in the set band is light that is reflected by the human eye and exited after passing through the optical structure 100, so that the tracking structure 220 can track the movement of the human eye. For a detailed description of the set band, please refer to the previous section, which will not be repeated here.

For example, the tracking structure may be an infrared camera.

For example, the display apparatus may be a virtual reality (VR) or mixed reality (MR) near-eye display apparatus.

The following points required to be explained:
(1) the drawings of the embodiments of the present disclosure only relate to the structures related to the embodiments of the present disclosure, and other structures can refer to the general design.
(2) without conflict, the embodiments of the present disclosure and the features in the embodiments may be combined with each other.

The above is only the specific embodiment of this disclosure, but the protection scope of the present disclosure is not limited thereto. Any person familiar with the technical field can easily think of changes or substitutions within the technical scope disclosed in the present disclosure, and they should be included in the protection scope of the present disclosure. Therefore, the scope of protection of the present disclosure should be based on the scope of protection of the claims.

1. An optical structure, comprising a light incident side and a light exit side, comprising:
a lens structure, comprising a first surface and a second surface disposed opposite each other, the first surface being a surface of the lens structure on the light incident side;
a beam splitting film, located on a side of the first surface away from the second surface;
a phase retardation film, located on a side of the second surface away from the first surface; and
a reflective polarizing film, located on the side of the second surface away from the first surface,
wherein the beam splitting film comprises a plurality of film layers arranged in a stacked manner along a thickness direction of the beam splitting film, the plurality of film layers comprises a plurality of metal layers and at least one non-metal layer, one or more non-metal layer of the at least one non-metal layer are disposed between two adjacent metal layers of the plurality of metal layers,
the plurality of metal layers comprises a mixed metal layer, a material of the mixed metal layer comprises at least two metals, and the at least two metals comprise a first metal and a second metal,
a non-metal layer that is in direct contact with the mixed metal layer and located on a side of the mixed metal layer close to the lens structure is a layer to be deposited, at least part of the first metal of the mixed metal layer is in direct contact with the layer to be deposited, and an interfacial energy between the first metal and the layer to be deposited is less than an interfacial energy between the second metal and the layer to be deposited.

2. The optical structure according to claim 1, wherein a content of the first metal in the mixed metal layer is a ratio of a mass of the first metal to a total mass of the mixed metal layer, and the content of the first metal in the mixed metal layer is not greater than 30%.

3. The optical structure according to claim 2, wherein a light absorptance of the second metal is less than a light absorptance of the first metal, and the content of the first metal in the mixed metal layer is not greater than 15%.

4. The optical structure according to claim 1, wherein the mixed metal layer comprises a first-type mixed metal layer, and the first metal of the first-type mixed metal layer is doped in the second metal.

5. The optical structure according to claim 4, wherein the first type of mixed metal layer comprises a first mixed metal layer, and the first metal of the first mixed metal layer is uniformly doped in the second metal.

6. The optical structure according to claim 4, wherein the first type of mixed metal layer comprises a second mixed metal layer, along a thickness direction of the second mixed metal layer, a ratio of the first metal to the second metal is variable.

7. The optical structure according to claim 6, wherein, in a thickness direction of the mixed metal layer and away from the lens structure, the ratio of the first metal to the second metal first decreases and then increases.

8. The optical structure according to claim 1, wherein the mixed metal layer comprises a second-type mixed metal layer, the second-type mixed metal layer comprises a plurality of sublayers arranged in a stacked manner, the plurality of sublayers comprises a nearest sublayer closest to the lens structure, and a material of the nearest sublayer comprises the first metal.

9. The optical structure according to claim 8, wherein the material of the nearest sublayer of the second-type mixed metal layer is the first metal, and a material of each sublayer of the plurality of sublayers other than the nearest sublayer is the second metal.

10. The optical structure according to claim 9, wherein a thickness of the nearest sublayer is not greater than 2 nm.

11. The optical structure according to claim 8, wherein the material of the nearest sublayer of the second type mixed metal layer further comprises the second metal, and a content of the first metal in the nearest sublayer is not greater than 30%.

12. The optical structure according to claim 11, wherein the plurality of sublayers further comprises a farthest sublayer farthest away from the lens structure, a material of the farthest sublayer comprises the first metal and the second metal, a content of the first metal in the farthest sublayer is not greater than 30%, and a material of each sublayer of the plurality of sublayers other than the nearest sublayer and the farthest sublayer is the second metal.

13. The optical structure according to claim 8, wherein a material of a non-metal layer in direct contact with the nearest sublayer is an oxide of the first metal.

14. The optical structure according to claim 1, wherein a thickness of the mixed metal layer is in a range from 5 nm to 25 nm.

15. The optical structure according to claim 14, wherein the thickness of the mixed metal layer is not greater than 15 nm.

16. The optical structure according to claim 1, wherein the first metal is one selected from the group consisting of aluminum, nickel, chromium, zinc, copper, gold, titanium, indium, germanium, and the second metal is silver.

17. The optical structure according to claim 1, wherein the at least one non-metal layer comprises a plurality of non-metal layers, the plurality of metal layers comprises a nearest metal layer closest to the lens structure and a farthest metal layer farthest away from the lens structure, at least one layer of the plurality of non-metal layers is disposed between the nearest metal layer and the lens structure, and at least one layer of the plurality of non-metal layers is disposed on a side of the farthest metal layer away from the lens structure.

18. A display apparatus, comprising a display screen and an optical structure;
the optical structure, comprising a light incident side and a light exit side, comprising:
a lens structure, comprising a first surface and a second surface disposed opposite each other, the first surface being a surface of the lens structure on the light incident side;
a beam splitting film, located on a side of the first surface away from the second surface;
a phase retardation film, located on a side of the second surface away from the first surface; and
a reflective polarizing film, located on the side of the second surface away from the first surface,
wherein the beam splitting film comprises a plurality of film layers arranged in a stacked manner along a thickness direction of the beam splitting film, the plurality of film layers comprises a plurality of metal layers and at least one non-metal layer, one or more non-metal layer of the at least one non-metal layer are disposed between two adjacent metal layers of the plurality of metal layers,
the plurality of metal layers comprises a mixed metal layer, a material of the mixed metal layer comprises at least two metals, and the at least two metals comprise a first metal and a second metal,
a non-metal layer that is in direct contact with the mixed metal layer and located on a side of the mixed metal layer close to the lens structure is a layer to be deposited, at least part of the first metal of the mixed metal layer is in direct contact with the layer to be deposited, and an interfacial energy between the first metal and the layer to be deposited is less than an interfacial energy between the second metal and the layer to be deposited;
wherein the display screen is located on the light incident side of the optical structure.

19. The display apparatus according to claim 18, further comprising a tracking structure, wherein the tracking structure is located on the light incident side of the optical structure, the tracking structure is configured to receive light in a set band and exited from the optical structure, and the display screen comprises a micro organic light-emitting diode display screen.

20. The display apparatus according to claim 18, wherein a content of the first metal in the mixed metal layer is a ratio of a mass of the first metal to a total mass of the mixed metal layer, and the content of the first metal in the mixed metal layer is not greater than 30%.
